(19) United States
(12) Patent Application Publication
(10) Pub. No.: US 2022/0260315 A1
(43) Pub. Date: Aug. 18, 2022

(54) HEAT EXCHANGER

(71) Applicant: MITSUBISHI HEAVY INDUSTRIES, LTD., Tokyo (JP)

(72) Inventors: Keisuke YOSHIDA, Tokyo (JP); Takeshi KANEKO, Tokyo (JP); Koichi TANIMOTO, Tokyo (JP); Hiroyuki NAKAHARAI, Tokyo (JP); Yuta TAKAHASHI, Tokyo (JP); Yoichi UEFUJI, Tokyo (JP); Nobuhide HARA, Tokyo (JP)

(21) Appl. No.: 17/583,519

(22) Filed: Jan. 25, 2022

(30) Foreign Application Priority Data
Feb. 15, 2021 (JP) 2021-021512

(51) Int. Cl. F28C 3/12; F02C 3/28

(52) U.S. Cl. CPC F28C 3/12; F02C 3/28

(57) ABSTRACT

A heat exchanger according to one embodiment includes: a cyclone flow path into which a first fluid is introduced along a tangential direction, the first fluid flowing downward in the cyclone flow path; a lower case located below the cyclone flow path and forming a lower space having a flow path area larger than that of the cyclone flow path; a first outlet flow path located on an outer peripheral side of the cyclone flow path, the first outlet flow path communicating with the lower space; a second inlet flow path into which a second fluid is introduced, the second inlet flow path being located on the outer peripheral side of the cyclone flow path; a second outlet flow path located on an inner peripheral side of the cyclone flow path; and a second intermediate flow path connecting the second inlet flow path and the second outlet flow path.

### CROSS-REFERENCE TO RELATED APPLICATIONS

This application claims the benefit of priority to Japanese Patent Application Number 2021-021512 filed on Feb. 15, 2021. The entire contents of the above-identified application are hereby incorporated by reference.

### TECHNICAL FIELD

The present disclosure relates to a heat exchanger.

### RELATED ART

For example, in a gas turbine combined cycle (GTCC) plant for power generation, a fuel gas heater (FGH) is installed in a fuel system for controlling the temperature of fuel supplied to the gas turbine. In the fuel gas heater, fuel gas is heated by heat exchange with heated water from heat recovery steam generators (HRSGs). In other words, the fuel gas heater is a heat exchanger.

### SUMMARY

In the fuel gas heater described above, the fuel gas contains sulfur (S) content, and thus particles of ferric sulfide (FeS) may be generated as foreign matter by the sulfur content reacting with iron (Fe) content contained in a container, a heat transfer tube, or the like of the fuel gas heater. Thus, when the foreign matter adheres to a heat transfer surface in the fuel gas heater, that is, the heat exchanger, the heat transfer coefficient on the heat transfer surface decreases, and heat exchange efficiency decreases. In addition, long-term use poses a risk of the foreign matter accumulating and blocking the flow path. Accordingly, the heat exchanger is preferably configured such that the foreign matter does not easily adhere to the heat transfer surface.

In view of the above, an object of at least one embodiment of the present disclosure is to provide a heat exchanger in which foreign matter does not easily adhere.

(1) A heat exchanger according to at least one embodiment of the present disclosure includes: a cyclone flow path into which a first fluid is introduced along a tangential direction, the first fluid flowing downward in the cyclone flow path; a lower case located below the cyclone flow path and forming a lower space having a flow path area larger than that of the cyclone flow path; a first outlet flow path located on an outer peripheral side of the cyclone flow path, the first outlet flow path communicating with the lower space; a second inlet flow path into which a second fluid is introduced, the second inlet flow path being located on the outer peripheral side of the cyclone flow path; a second outlet flow path located on an inner peripheral side of the cyclone flow path; and a second intermediate flow path connecting the second inlet flow path and the second outlet flow path.

In accordance with at least one embodiment of the present disclosure, a heat exchanger facilitates removal of foreign matter.

### BRIEF DESCRIPTION OF DRAWINGS

The disclosure will be described with reference to the accompanying drawings, wherein like numbers reference like elements.

FIG. 1 is a schematic exterior view of a heat exchanger according to one embodiment.

FIG. 2A is a schematic diagram for illustrating an overview of a first flow path according to one embodiment.

FIG. 2B is a schematic diagram for illustrating an overview of a second flow path according to some embodiments.

FIG. 2C is a schematic diagram for illustrating an overview of a first flow path according to other embodiments.

FIG. 3A is a cross-sectional view taken along line A-A in FIGS. 1, 2A, and 2B.

FIG. 3B is a cross-sectional view taken along line B-B in FIGS. 1, 2A, and 2B.

FIG. 3C is a cross-sectional view taken along line C-C in FIGS. 1, 2A, and 2B.

FIG. 3D is a cross-sectional view taken along line D-D in FIGS. 1, 2A, and 2B.

FIG. 3E is a cross-sectional view taken along line E-E in FIGS. 1, 2A, and 2B.

### DESCRIPTION OF EMBODIMENTS

Hereinafter, some embodiments of the present disclosure will be described with reference to the accompanying drawings. However, dimensions, materials, shapes, relative arrangements, or the like of components described in the embodiments or in the drawings are not intended to limit the scope of the present disclosure thereto, and are merely illustrative examples.

For instance, an expression indicating relative or absolute arrangement such as “in a direction”, “along a direction”, “parallel”, “orthogonal”, “centered”, “concentric” or “coaxial” shall not be construed as indicating only the arrangement in a strict literal sense, but also includes a state where the arrangement is relatively displaced by a tolerance, or by an angle or a distance within a range in which the same function can be achieved.

For instance, an expression indicating an equal state such as “same”, “equal”, or “uniform” shall not be construed as indicating only a state in which features are strictly equal, but also includes a state in which there is a tolerance or a difference within a range in which the same function can be achieved. Further, for instance, an expression indicating a shape such as a rectangular shape or a tube shape shall not be construed as only being a geometrically strict shape, but also includes a shape with unevenness, chamfered corners, or the like within a range in which the same effect can be achieved.

On the other hand, an expression such as “comprise”, “include”, “have”, “contain” or “constitute” is not intended to be exclusive of other constituent elements.

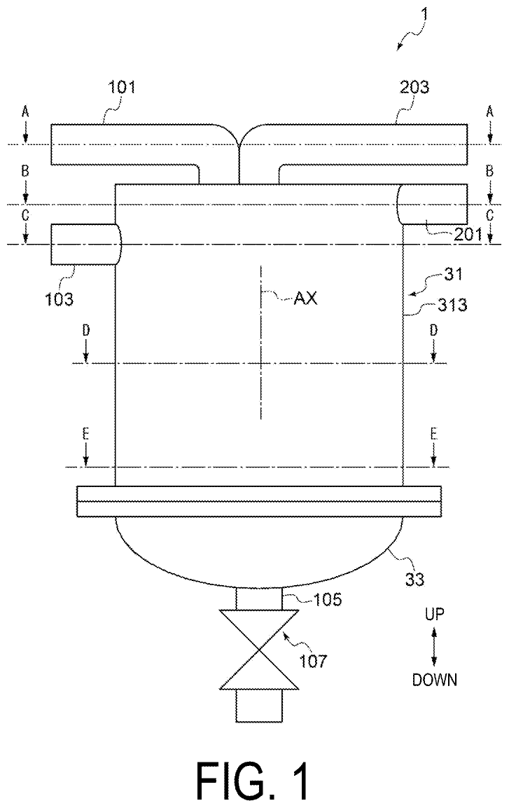

FIG. 1 is a schematic exterior view of a heat exchanger according to one embodiment.

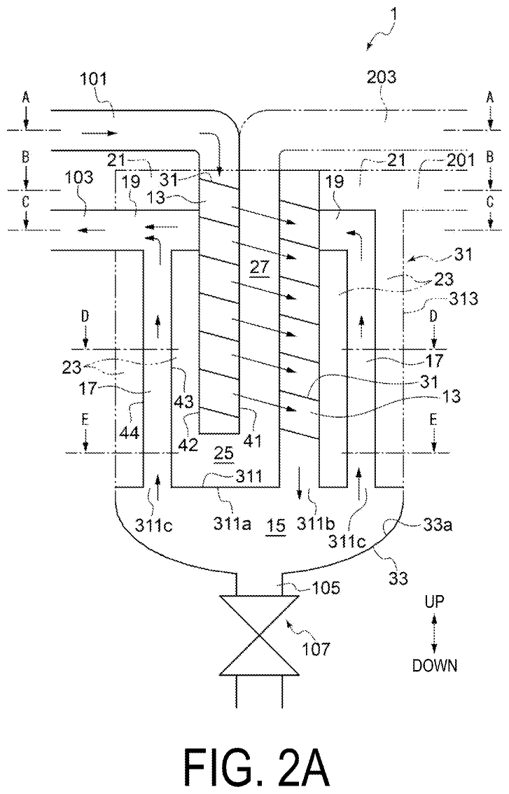

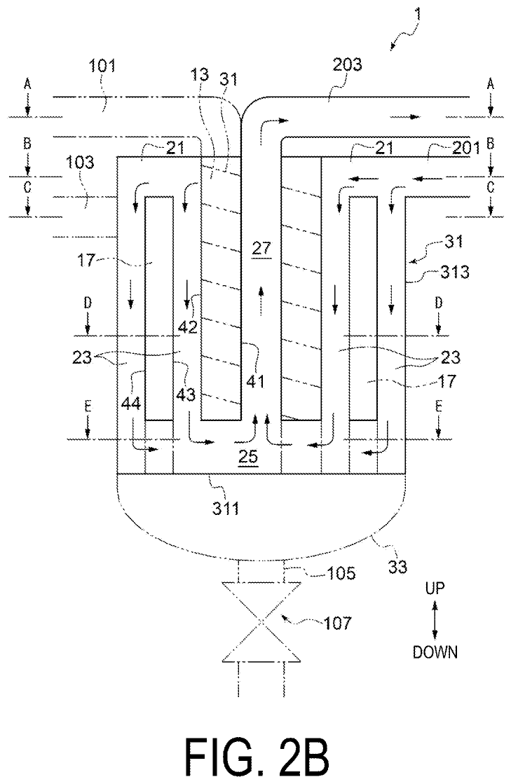

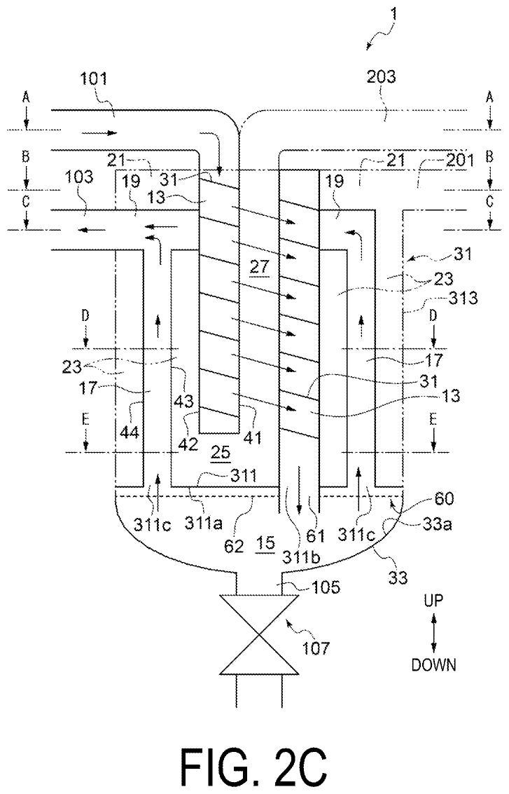

FIG. 2A is a schematic diagram for illustrating an overview of a first flow path according to one embodiment.

FIG. 2B is a schematic view for illustrating an overview of a second flow path according to some embodiments.

FIG. 2C is a schematic diagram for illustrating an overview of a first flow path according to other embodiments.

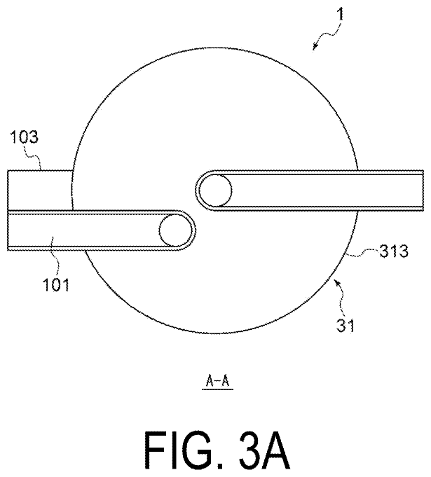

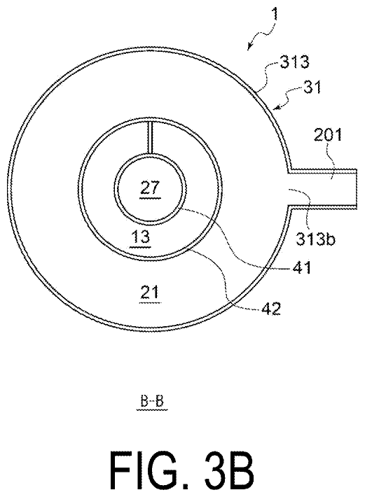

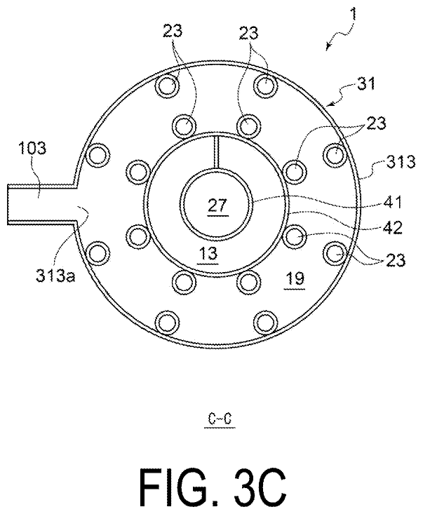

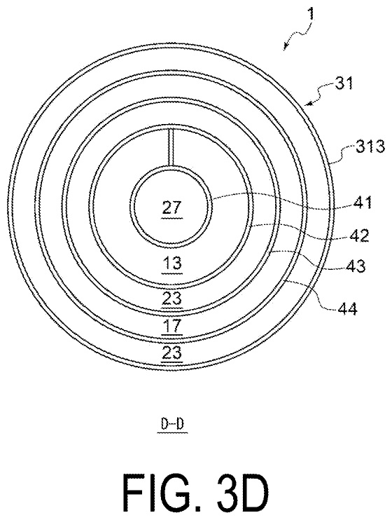

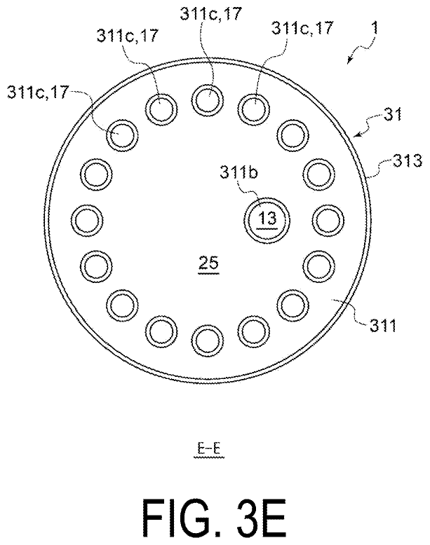

FIG. 3A is a cross-sectional view taken along line A-A in FIGS. 1, 2A, and 2B.

FIG. 3B is a cross-sectional view taken along line B-B in FIGS. 1, 2A, and 2B.

FIG. 3C is a cross-sectional view taken along line C-C in FIGS. 1, 2A, and 2B.

FIG. 3D is a cross-sectional view taken along line D-D in FIGS. 1, 2A, and 2B.

FIG. 3E is a cross-sectional view taken along line E-E in FIGS. 1, 2A, and 2B.

A heat exchanger 1 according to some embodiments is for causing a heat exchange between a first fluid and a second fluid. The heat exchanger 1 according to some embodiments can be used for heat exchange between, for example, a fuel gas FG having a relatively low temperature and water W having a relatively high temperature.

The heat exchanger 1 according to some embodiments can be used for raising the temperature of a fuel gas used as a fuel in, for example, a gas turbine or the like.

Note that for convenience of explanation, the following description assumes that the first fluid is the fuel gas FG and that the second fluid is the water W.

The heat exchanger 1 according to some embodiments includes a cyclone flow path 13, into which the first fluid is introduced along a tangential direction and flows downward, and a lower case 33, which is located below the cyclone flow path 13 and forms a lower space 15 having a flow path area larger than that of the cyclone flow path 13. The heat exchanger 1 according to at least one embodiment of the present disclosure includes a first outlet flow path 17, which is located on an outer peripheral side of the cyclone flow path 13 and communicates with the lower space 15, and a second inlet flow path 23, which is located on an outer peripheral side of the cyclone flow path 13 and into which a second fluid is introduced. The heat exchanger 1 according to at least one embodiment of the present disclosure includes the second outlet flow path 27, which is located on an inner peripheral side of the cyclone flow path 13, and a second intermediate flow path 25, which connects the second inlet flow path 23 and the second outlet flow path 27.

The heat exchanger 1 according to some embodiments includes a first annular flow path 19 and a second annular flow path 21.

The heat exchanger 1 according to some embodiments includes an upper case 31, in which are formed the cyclone flow path 13, the first outlet flow path 17, the first annular flow path 19, the second annular flow path 21, the second inlet flow path 23, the second intermediate flow path 25, and the second outlet flow path 27.

The heat exchanger 1 according to some embodiments includes a first supply flow path 101, which is provided outside the upper case 31, a first discharge flow path 103, a second supply flow path 201, and a second discharge flow path 203.

The heat exchanger 1 according to some embodiments includes a lower communicating portion 105, which is provided outside the lower case 33.

In the heat exchanger 1 according to some embodiments, the upper case 31 and the lower case 33 may be flange-coupled, for example, to facilitate attachment and detachment of the lower case 33 to and from the upper case 31.

Note that in the heat exchanger 1 according to some embodiments, the upper case 31 has a tube shape. Thus, in the following description, “circumferential direction” refers to a circumferential direction about an axis AX of the upper case 31 having the tube shape. Similarly, in the following description, “radial direction” refers to a radial direction about the axis Ax, and “axial direction” refers to an axis Ax direction.

In the heat exchanger 1 according to some embodiments, the position of the upper case 31 is set so that the axis Ax direction coincides with the vertical direction.

The heat exchanger 1 according to some embodiments can be manufactured by, for example, an additive manufacturing method.

### First Supply Flow Path 101

The first supply flow path 101 according to some embodiments is a pipe that is connected to an upstream pipe (not illustrated) through which the first fluid (fuel gas FG) flows, and that supplies the first fluid from the upstream pipe to the heat exchanger 1. The first supply flow path 101 according to some embodiments is disposed, for example, above the upper case 31. The first supply flow path 101 according to some embodiments is connected to the cyclone flow path 13.

### Cyclone Flow Path 13

The cyclone flow path 13 according to some embodiments is a flow path that is located on an outer peripheral side of the second discharge flow path 203, which is described below, and extends in a spiral manner so as to surround an outer periphery of the second discharge flow path 203. In the cyclone flow path 13 according to some embodiments, a flow path width in an up-down direction is defined by a partition wall 35 having a spiral shape. Further, in the cyclone flow path 13 according to some embodiments, a flow path width in a radial direction about a central axis of a spiral is defined by a wall portion on an outer peripheral side and a wall portion on an inner peripheral side.

Note that in a configuration in which the first fluid is introduced from the first supply flow path 101 along a tangential direction of the cyclone flow path 13, the first fluid flows downward in the cyclone flow path 13 while turning in a spiral manner, even in the absence of the partition wall 35 having the spiral shape. Thus, the heat exchanger 1 according to some embodiments may or may not have the partition wall 35 having the spiral shape.

The cyclone flow path 13 according to some embodiments has a lower end portion connected to the lower space 15.

### Lower Space 15

The lower space 15 according to some embodiments is an interior space of the heat exchanger 1, the interior space being defined by an inside surface 33a of the lower case 33 and a bottom surface 311a of a lower partition wall 311 in the upper case 31.

The lower space 15 according to some embodiments has a flow path area larger than that of the cyclone flow path 13.

Note that in some embodiments, the lower space 15 is connected to the cyclone flow path 13 via an opening 311b of the lower partition wall 311. In some embodiments, the lower space 15 is connected to the first outlet flow path 17 via a plurality of openings 311c in the lower partition wall 311.

In some embodiments, the lower space 15 is connected to the lower communicating portion 105, which is provided outside the lower case 33.

Note that in other embodiments illustrated in FIG. 2C, a strainer 60 may be provided in the lower space 15. The strainer 60 according to other embodiments is for effectively collecting particles of iron sulfide (FeS) generated due to sulfur (S) content contained in a fuel gas FG as the first fluid, for example.

In the other embodiments illustrated in FIG. 2C, a lower end of the cyclone flow path 13 preferably extends below a collecting surface 62 in the strainer 60, the collecting surface collecting foreign matter, via the opening 311b of the lower partition wall 311 and an opening 61 of the strainer 60.

### Lower Communicating Portion 105

As described above, the lower communicating portion 105 according to some embodiments is a flow path provided below and outside the lower case 33 and connected to the lower space 15. An on-off valve 107 is provided in the lower communicating portion 105. When the on-off valve 107 opens, the lower space 15 and the outside of the heat exchanger 1 communicate with each other via the lower communicating portion 105. When the on-off valve 107 closes, communication via the lower communicating portion 105 between the lower space 15 and the outside of the heat exchanger 1 is blocked.

### First Outlet Flow Path 17

The first outlet flow path 17 according to some embodiments is a flow path that is located on the outer peripheral side of the cyclone flow path 13 and communicates with the lower space 15.

As illustrated in FIG. 3E, the first outlet flow path 17 according to some embodiments is, in a lower region close to the lower space 15, a group of flow paths each having a circular cross section with a relatively small diameter, the flow paths being each connected to a corresponding one of a plurality of openings 311c, which are formed at intervals in the circumferential direction.

As illustrated in FIG. 3D, the first outlet flow path 17 according to some embodiments is a flow path having an annular cross section at a location away from the lower space 15.

The first outlet flow path 17 according to some embodiments includes an upper end connected to the first annular flow path 19.

### First Annular Flow Path 19

As illustrated in FIG. 3C, the first annular flow path 19 according to some embodiments is a flow path having an annular shape with an inside diameter and an outside diameter larger than those of the first outlet flow path 17, the flow path being on the outer peripheral side of the cyclone flow path 13 above the first outlet flow path 17. A wall portion outward in the radial direction of the first annular flow path 19 according to some embodiments is a peripheral wall 313 of the upper case 31.

The first annular flow path 19 according to some embodiments is connected to the first discharge flow path 103 via an opening 313a, which is formed in the peripheral wall 313 of the upper case 31.

### First Discharge Flow Path 103

The first discharge flow path 103 according to some embodiments is a pipe for discharging the first fluid from the first annular flow path 19 to the outside of the heat exchanger 1. The first discharge flow path 103 according to some embodiments is connected to a pipe, located downstream (not illustrated), through which the first fluid (fuel gas FG) flows.

### Second Supply Flow Path 201

The second supply flow path 201 according to some embodiments is a pipe connected to an upstream pipe (not illustrated) through which the second fluid (water W) flows, and supplies the second fluid from the upstream pipe to the heat exchanger 1. The second supply flow path 201 according to some embodiments is disposed, for example, on the side of the upper case 31. As illustrated in FIG. 3B, the second supply flow path 201 according to some embodiments is connected to the second annular flow path 21 via an opening 313b, which is formed in the peripheral wall 313 of the upper case 31.

### Second Annular Flow Path 21

As illustrated in FIG. 3B, the second annular flow path 21 according to some embodiments is a flow path on the outer peripheral side of the cyclone flow path 13 above the second inlet flow path 23, which is described below, the flow path having, for example, an annular shape with an inside diameter and an outside diameter that are equivalent to those of the first annular flow path 19, which is described above. The radial direction outer wall portion of the second annular flow path 21 according to some embodiments is the peripheral wall 313 of the upper case 31.

The second annular flow path 21 according to some embodiments has its lower portion connected to an upper end of the second inlet flow path 23.

### Second Inlet Flow Path 23

The second inlet flow path 23 according to some embodiments is a flow path into which the second fluid is introduced, the flow path being located on the outer peripheral side of the cyclone flow path 13.

As illustrated in FIG. 3C, the second inlet flow path 23 according to some embodiments is a group of a plurality of flow paths each having a circular cross section with a relatively small diameter, the plurality of flow paths being disposed at intervals in the circumferential direction in a relatively upper region close to the second annular flow path 21.

As illustrated in FIG. 3D, the second inlet flow path 23 according to some embodiments is a flow path having an annular cross section at a location away from the second annular flow path 21. Note that the second inlet flow path 23 according to some embodiments is disposed on an inner side and an outer side in the radial direction, with the first outlet flow path 17 interposed therebetween.

The second inlet flow path 23 according to some embodiments has a lower end connected to the second intermediate flow path 25.

### Second Intermediate Flow Path 25

The second intermediate flow path 25 according to some embodiments is, as described below, a flow path connecting the second outlet flow path 27 located on the inner peripheral side of the cyclone flow path 13 and the second inlet flow path 23.

The second intermediate flow path 25 according to some embodiments is a layered path extending in the radial direction, and is penetrated along an up-down direction by the cyclone flow path 13 and a group of a plurality of flow paths of the first outlet flow path 17, the plurality of flow paths each having a relatively small diameter.

### Second Outlet Flow Path 27

The second outlet flow path 27 according to some embodiments is a path located on the inner peripheral side of the cyclone flow path 13 and extends along the axis Ax direction.

The second outlet flow path 27 according to some embodiments has a lower end connected to the second intermediate flow path 25 and an upper end connected to the second discharge flow path 203.

### Second Discharge Flow Path 203

The second discharge flow path 203 according to some embodiments is a pipe for discharging the second fluid from the second outlet flow path 27 to the outside of the heat exchanger 1. The second discharge flow path 203 according to some embodiments is connected to a downstream pipe (not illustrated) through which the second fluid (water) flows.

### Flow of Fluids

In the heat exchanger 1 according to some embodiments, the first fluid and the second fluid flow through the inside of the heat exchanger 1 as described below.

In the heat exchanger 1 according to some embodiments, the first fluid flows through the inside of the heat exchanger 1 in the order of the first supply flow path 101, the cyclone flow path 13, the lower space 15, the first outlet flow path 17, the first annular flow path 19, and the first discharge flow path 103.

In the heat exchanger 1 according to some embodiments, the second fluid flows through the inside of the heat exchanger 1 in the order of the second supply flow path 201, the second annular flow path 21, the second inlet flow path 23, the second intermediate flow path 25, the second outlet flow path 27, and the second discharge flow path 203.

In the heat exchanger 1 according to some embodiments, heat is exchanged between the first fluid and the second fluid in the process of flowing through the inside of the heat exchanger 1 as described above.

For example, as illustrated in FIG. 3D, the heat transfer amount increases in a region where the flow path through which the first fluid flows and the flow path through which the second fluid flows are adjacent to each other with a wall portion interposed therebetween.

For example, as illustrated in FIG. 3D, the second outlet flow path 27 and the cyclone flow path 13 are adjacent to each other in the radial direction with a tubular wall portion 41 interposed therebetween.

The cyclone flow path 13 and the second inlet flow path 23 on the inner side in the radial direction are adjacent to each other in the radial direction with a tubular wall portion 42 interposed therebetween.

The second inlet flow path 23 and the first outlet flow path 17 on the inner side in the radial direction are adjacent to each other in the radial direction with a tubular wall portion 43 interposed therebetween.

The first outlet flow path 17 and the second inlet flow path 23 on the outer side in the radial direction are adjacent to each other in the radial direction with a tubular wall portion 44 interposed therebetween.

In the heat exchanger 1 according to some embodiments thus configured, if the cyclone flow path 13 is used as a flow path for performing heat exchange with the second fluid, an inner wall surface of the cyclone flow path 13, that is, the wall surface of the tubular wall portions 41, 42 facing the cyclone flow path 13, becomes a heat transfer surface. The fluid flowing through the cyclone flow path 13 makes a swirl flow in the cyclone flow path 13, making it easier to increase flow velocity. Thus, foreign matter is less likely to adhere to the heat transfer surface, and foreign matter that does adhere is easily removed by the flow of the fluid. This suppresses a decrease in the heat transfer coefficient on the heat transfer surface and suppresses a decrease in heat exchange efficiency. Furthermore, long-term use of the heat exchanger 1 according to some embodiments poses little risk of blockage of the flow path due to accumulation of foreign matter.

In addition, in the heat exchanger 1 according to some embodiments, the flow rate of the fluid decreases in the lower space 15 having a flow path area larger than that of the cyclone flow path 13, facilitating separation of foreign matter from the fluid. This can suppress foreign matter flowing downstream of the lower space 15 to suppress problems downstream of the lower space 15 such as attachment of foreign matter to the wall surface of the flow path and clogging of the flow path.

In the heat exchanger 1 according to some embodiments, the second inlet flow path 23 is preferably adjacent to the cyclone flow path 13 with a flow path wall (tubular wall portion 42), which is on the outer peripheral side of the cyclone flow path 13, interposed therebetween.

This allows for efficient heat exchange between the first fluid flowing through the cyclone flow path 13 and the second fluid flowing through the second inlet flow path 23.

In the heat exchanger 1 according to some embodiments, the second outlet flow path 27 is preferably adjacent to the cyclone flow path 13 with a flow path wall (tubular wall 41), which is on the inner peripheral side of the cyclone flow path 13, interposed therebetween.

This allows for active heat exchange between the first fluid flowing through the cyclone flow path 13 and the second fluid flowing through the second outlet flow path 27.

In the heat exchanger 1 according to some embodiments, the second inlet flow path 23 is preferably adjacent to the first outlet flow path 17 on the inner peripheral side and the outer peripheral side with flow path walls (tubular walls 43, 44) of the first outlet flow path 17 interposed therebetween.

This allows for active heat exchange between the first fluid flowing through the first outlet flow path 17 and the second fluid flowing through the second inlet flow path 23.

In the heat exchanger 1 according to some embodiments, the flow path width of the cyclone flow path 13 in an up-down direction is preferably defined by the partition wall 35 having a spiral shape.

The definition of the flow path width in the up-down direction by the partition wall 35 having the spiral shape facilitates an increase in the flow rate of the fluid in the cyclone flow path 13, as compared with a case where the partition wall 35 having the spiral shape is not provided.

The heat exchanger 1 according to some embodiments preferably includes the lower communicating portion 105, which connects to the lower case 33 and communicates with the lower space 15 and the outside.

This allows foreign matter accumulated in the lower space 15 to be discharged to the outside of the lower space 15 without disassembling the heat exchanger 1, thus facilitating removal of the foreign matter accumulated in the lower space 15.

The heat exchanger 1 according to some embodiments preferably includes the strainer 60, which is disposed in the lower space 15.

This can further suppress an inflow of the foreign matter downstream of the lower space 15.

Note that the strainer 60 can be configured to be detachable from the lower case 33 to facilitate replacement and cleaning of the strainer 60.

Note that a pressure differential gauge may be installed between the first supply flow path 101 and the first discharge flow path 103, and the on-off valve 107 may be controlled by a control device (not illustrated) so as to open when the pressure differential between the first supply flow path 101 and the first discharge flow path 103 exceeds a predetermined threshold value. This can automate discharge of foreign matter.

The present disclosure is not limited to the above-described embodiments, and includes embodiments obtained by modifying the above-described embodiments and embodiments obtained by appropriately combining these embodiments.

The contents described in each of the above embodiments are understood as follows, for example.

(1) A heat exchanger 1 according to at least one embodiment of the present disclosure includes a cyclone flow path 13 into which a first fluid is introduced along a tangential direction, the first fluid flowing downward in the cyclone flow path, and a lower case 33 located below the cyclone flow path 13 and forming a lower space 15 having a flow path area larger than that of the cyclone flow path 13. The heat exchanger 1 according to at least one embodiment of the present disclosure includes a first outlet flow path 17 located on an outer peripheral side of the cyclone flow path 13, the first outlet flow path 17 communicating with the lower space 15, and a second inlet flow path 23 into which a second fluid is introduced, the second inlet flow path 23 being located on the outer peripheral side of the cyclone flow path 13. The heat exchanger 1 according to at least one embodiment of the present disclosure includes a second outlet flow path 27 located on an inner peripheral side of the cyclone flow path 13, and a second intermediate flow path 25 connecting the second inlet flow path 23 and the second outlet flow path 27.

According to the configuration of (1) above, the cyclone flow path 13 is a flow path for exchanging heat with the second fluid, and an inner wall surface of the cyclone flow path 13 (wall surfaces of the tubular wall portions 41, 42 facing the cyclone flow path 13) is a heat transfer surface. The fluid flowing through the cyclone flow path 13 makes a swirl flow in the cyclone flow path 13, making it easier to increase flow velocity. Thus, foreign matter is less likely to adhere to the heat transfer surface, and even when foreign matter does adhere thereto, the foreign matter is easily removed by the flow of the fluid. This suppresses a reduction in the heat transfer coefficient on the heat transfer surface, and suppresses a reduction in the heat exchange efficiency.

In addition, according to the configuration of (1) above, in the lower space 15, the flow path area of which is larger than that of the cyclone flow path 13, the flow velocity of the fluid decreases, facilitating separation of foreign matter from the fluid. This can suppress foreign matter flowing downstream of the lower space 15 to suppress problems downstream of the lower space 15 such as attachment of foreign matter to the wall surface of the flow path and clogging of the flow path.

(2) In some embodiments, the second inlet flow path 23 in the configuration of (1) described above is preferably adjacent to the cyclone flow path 13 with a flow path wall (tubular wall portion 42), which is on the outer peripheral side of the cyclone flow path 13, interposed therebetween.

According to the configuration of (2) above, heat can be efficiently exchanged between the first fluid flowing through the cyclone flow path 13 and the second fluid flowing through the second inlet flow path 23.

(3) In some embodiments, the second outlet flow path 27 in the configuration of (1) or (2) above is preferably adjacent to the cyclone flow path 13 across a flow path wall (tubular wall portion 41) on the inner peripheral side of the cyclone flow path 13.

According to the configuration of (3) above, heat can be actively exchanged between the first fluid flowing through the cyclone flow path 13 and the second fluid flowing through the second outlet flow path 27.

(4) In some embodiments, the second inlet flow path 23 in any one of the configurations (1) to (3) described above is preferably adjacent to the first outlet flow path 17 on the inner peripheral side and the outer peripheral side with flow path walls (tubular wall portions 43, 44) of the first outlet flow path 17 interposed therebetween.

According to the configuration of (4) above, heat can be actively exchanged between the first fluid flowing through the first outlet flow path 17 and the second fluid flowing through the second inlet flow path 23.

(5) In some embodiments, the cyclone flow path 13 in any one of the configurations (1) to (4) described above preferably has a flow path width in an up-down direction defined by a partition wall 35 having a spiral shape.

According to the configuration of (5) above, the flow path width in the up-down direction is defined by the partition wall 35 having the spiral shape, thereby facilitating an increase in the flow rate of the fluid in the cyclone flow path 13, as compared with a case where the partition wall 35 having the spiral shape is not provided.

(6) In some embodiments, preferably, a lower communicating portion 105 in any one of the configurations (1) to (5) described above is connected to the lower case 33 and enables the lower space 15 to communicate with an outside space.

According to the configuration of (6) described above, foreign matter accumulated in the lower space 15 can be discharged to the outside of the lower space 15 without disassembling the heat exchanger 1, facilitating removal of foreign matter accumulated in the lower space 15.

(7) In some embodiments, any one of the configurations (1) to (6) described above preferably further includes a strainer 60 disposed in the lower space 15.

The configuration of (7) above can further suppress an inflow of foreign matter downstream of the lower space 15.

While preferred embodiments of the invention have been described as above, it is to be understood that variations and modifications will be apparent to those skilled in the art without departing from the scope and spirit of the invention. The scope of the invention, therefore, is to be determined solely by the following claims.

1. A heat exchanger, comprising:
a cyclone flow path into which a first fluid is introduced along a tangential direction, the first fluid flowing downward in the cyclone flow path;
a lower case located below the cyclone flow path and forming a lower space having a flow path area larger than that of the cyclone flow path;
a first outlet flow path located on an outer peripheral side of the cyclone flow path, the first outlet flow path communicating with the lower space;
a second inlet flow path into which a second fluid is introduced, the second inlet flow path being located on the outer peripheral side of the cyclone flow path;
a second outlet flow path located on an inner peripheral side of the cyclone flow path; and
a second intermediate flow path connecting the second inlet flow path and the second outlet flow path.

2. The heat exchanger according to claim 1, wherein the second inlet flow path is adjacent to the cyclone flow path with a flow path wall on the outer peripheral side of the cyclone flow path interposed therebetween.

3. The heat exchanger according to claim 1, wherein the second outlet flow path is adjacent to the cyclone flow path with a flow path wall on the inner peripheral side of the cyclone flow path interposed therebetween.

4. The heat exchanger according to claim 1, wherein the second inlet flow path is adjacent to the first outlet flow path on the inner peripheral side and the outer peripheral side with flow path walls of the first outlet flow path interposed therebetween.

5. The heat exchanger according to claim 1, wherein a flow path width of the cyclone flow path in an up-down direction is defined by a partition wall having a spiral shape.

6. The heat exchanger according to claim 1, further comprising:
a lower communicating portion connected to the lower case and enabling the lower space to communicate with an outside space.

7. The heat exchanger according to claim 1, further comprising:
a strainer disposed in the lower space.
